(19) United States
(12) Patent Application Publication
(10) Pub. No.: US 2009/0295893 A1
(43) Pub. Date: Dec. 3, 2009

(54) INKJET RECORDING METHOD AND PRETREATMENT LIQUID FOR INKJET RECORDING

(75) Inventors: Ryozo Akiyama, Mishima-shi (JP); Hiroshi Kiyomoto, Hiratsuka-shi (JP)

Correspondence Address: TUROCY & WATSON, LLP, 127 Public Square, 57th Floor, Key Tower, CLEVELAND, OH, 44114, US

(73) Assignees: KABUSHIKI KAISHA TOSHIBA, Tokyo (JP); TOSHIBA TEC KABUSHIKI KAISHA, Tokyo (JP)

(21) Appl. No.: 12/410,740

(22) Filed: Mar. 25, 2009

Related U.S. Application Data
(60) Provisional application No. 61/056,530, filed on May 28, 2008.

(51) Int. Cl. B41J 2/17; C09D 5/00

(52) U.S. Cl. 347/96; 106/287.26

(57) ABSTRACT

According to an embodiment of the invention, in an inkjet printer, after attaching a colorless pretreatment liquid onto plain paper, at least one ink composition capable of reacting with the pretreatment liquid is injected, thereby forming an image. The pretreatment liquid contains at least one butane derivative selected from the group consisting of 3-methoxy-3-methyl-1-butanol, 1,3-butylene glycol and isoprene glycol, water and an organometal salt having COO⁻ in an organic skeleton thereof, and the ink composition contains a coloring material and water.

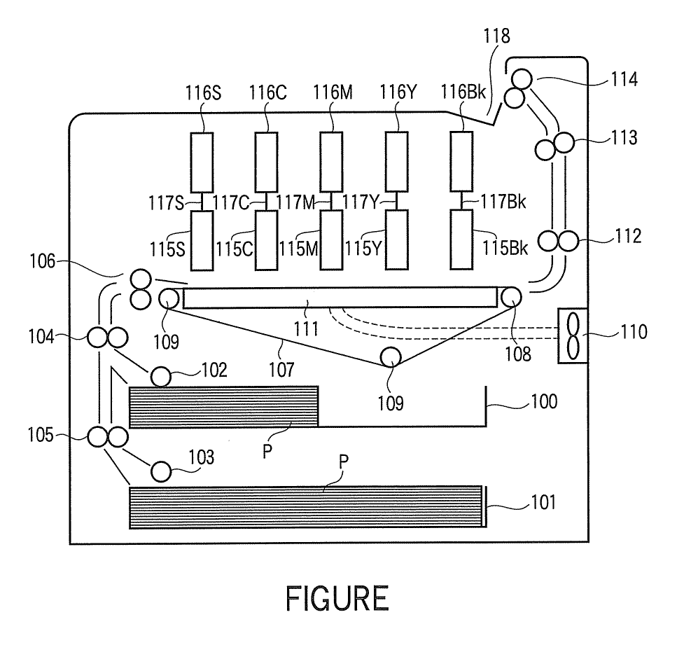

### CROSS-REFERENCE TO RELATED APPLICATION

This application is based upon and claims the benefit of priority from U.S. Provisional Application No. 61/056,530 filed on May 28, 2008, the entire contents of which are incorporated herein by reference.

### TECHNICAL FIELD

The present invention relates to an inkjet recording method and a pretreatment liquid for inkjet recording.

### BACKGROUND

In existing inks for inkjet recording, those composed of water as a major component and containing a water-soluble high-boiling point organic solvent such as glycols have been generally used. The water-soluble high-boiling point organic solvent is blended for the purpose of preventing drying or preventing clogging from occurring or the like. In case of recording on plain paper using such an ink, various problems occurred. Specifically, sufficient fixability is not always obtainable. According to circumstances, a non-uniform image which is estimated to be caused due to non-uniform distribution of a loading filler or a sizing agent on the surface of recording paper was generated. When a desired image is a color image, since inks of plural colors are superimposed one after another before they are fixed on paper, this issue is particularly problematical. In a boundary portion between images with a different color, there is generated a phenomenon named as bleeding, in which colors are blurred or non-uniformly intermixed. As a result, a satisfactory image was not obtained.

In order to form a favorable color image on plain paper, there is proposed a method of pretreating plain paper before injecting inks. In view of the fact that a pretreatment liquid is previously attached onto plain paper, this method is called a two-liquid feeding method. For example, there are known Japanese Patent No. 3745438, U.S. Pat. No. 6,084,619 and JP-A-10-193775.

In case of employing any two-liquid feeding method, the quality of the obtained image is favorable. However, since printing is performed by two-liquid feeding, a drying speed of a printed matter is slow as compared with that by one-liquid feeding. Also, since a resin component is contained in the ink to be used, the viscosity of the ink is high so that the storage stability is poor. Furthermore, since a wetting agent such as glycerin is contained in the pretreatment liquid, deterioration of paper due to the wetting agent, such as curl or cockling, is caused on printing paper after finally printing the inks thereon. In order to avoid this, the discharge amount of the pretreatment liquid must be restricted.

### SUMMARY

An object of the invention is to provide a method for inkjet recording on plain paper by a two-liquid feeding method, wherein deterioration of plain paper is suppressed and high-quality printing is performed.

Another object of the invention is to provide a pretreatment liquid for inkjet recording which is able to realize high-quality printing while suppressing deterioration of plain paper.

The invention is to provide a method for inkjet printing comprising:

attaching a colorless pretreatment liquid onto plain paper, the pretreatment liquid containing at least one butane derivative selected from the group consisting of 3-methoxy-3-methyl-1-butanol, 1,3-butylene glycol and isoprene glycol, water and an organometal salt having COO⁻ in an organic skeleton thereof; and

injecting at least one ink composition capable of reacting with the pretreatment liquid onto the plain paper after the pretreatment, thereby forming an image, the ink composition containing a coloring material and water.

Also, the invention is to provide a pretreatment liquid for inkjet recording which attached onto plain paper before forming an image with an ink composition on the plain paper by an inkjet printer, the pretreatment liquid comprising at least one butane derivative selected from the group consisting of 3-methoxy-3-methyl-1-butanol, 1,3-butylene glycol and isoprene glycol, water and an organometal salt having COO⁻ in an organic skeleton thereof.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### DESCRIPTION OF THE DRAWING

The accompanying drawing, which is incorporated in and constitutes a part of the specification, illustrates embodiments of the invention, and together with the general description given above and the detailed description of the embodiments given below, serves to explain the principles of the invention.

FIGURE shows an example of an inkjet recording apparatus to which an embodiment of the invention is applied.

### DETAILED DESCRIPTION

Embodiments of the invention are hereunder specifically described.

FIGURE is a cross-sectional view of a recording apparatus which is used in an inkjet recording method according to an embodiment of the invention. Paper cassettes 100 and 101 hold papers p having a different size from each other. A paper feed roller 102 or 103 takes out the paper p corresponding to the selected paper size from the paper cassette 100 or 101 and conveys it into conveyance roller pairs 104 and 105 and a resist roller pair 106.

A tension is given to a conveyance belt 107 by a drive roller 108 and two driven rollers 109. Holes are provided at prescribed intervals on the surface of the conveyance belt 107; and for the purpose of adsorbing the paper p onto the conveyance belt 107, a vacuum chamber 111 connected to a fan 110 is installed in the inside of the conveyance belt 107. Conveyance roller pairs 112, 113 and 114 are installed in the downstream of the paper conveyance direction of the conveyance belt 107.

In an upper part of the conveyance belt 107, five rows of inkjet heads for discharging an ink onto paper corresponding to an image data are arranged. An inkjet head 115S for discharging a pretreatment liquid, an inkjet head 115C for discharging a cyan ink (C), an inkjet head 115M for discharging a magenta ink (M), an inkjet head 115Y for discharging a yellow ink (Y) and an inkjet head 115Bk for discharging a black ink (Bk) are arranged in this order from the upstream. Furthermore, each of these inkjet heads 115 is provided with a treatment liquid cartridge 116S holding a pretreatment liquid therein and a cyan (C) ink cartridge 116C, a magenta (M) ink cartridge 116M, a yellow (Y) ink cartridge 116Y and a black (Bk) ink cartridge 116Bk, respectively, each holding an ink of each color therein. Each of these cartridges is connected to tubes 117S, 117C, 117M, 117Y and 117Bk, respectively.

In the inkjet heads, it is preferable that multi-drop printing is performed. The multi-drop printing is a printing method capable of changing the discharge droplet amount per dot. When this printing method is adopted, the printing amount of the discharge liquid per unit area can be changed, and it becomes possible to enhance the image quality by one pass.

For example, a high-image quality region can be enlarged by arbitrarily regulating the effect to be brought due to the reaction of the organometal salt by the discharge droplet amount. When the required image quality is on a usual level, the use amount of the pretreatment liquid can be reduced by controlling the discharge amount thereof. In that case, there is also obtained an effect for increasing a printing speed.

In the illustrated apparatus, the pretreatment liquid is coated at a prescribed position of the paper p using the inkjet head 115S, but it should not be construed that the invention is limited to such a configuration. The pretreatment liquid can also be coated on the whole of paper using a cylindrical coating roller.

An inkjet recording method according to an embodiment of the invention is described.

First of all, image processing for recording by an image processor (not illustrated) is initiated, and image data for recording are transferred into the respective inkjet heads 115S, 115C, 115M, 115Y and 115Bk. Also, one sheet of the paper p of a selected paper size is taken out each time from the paper cassette 100 or 101 by the paper feed roller 102 or 103 and conveyed to the conveyance roller pairs 104 and 105 and the resist roller pair 106. The resist roller pair 106 corrects a skew of the paper p and conducts the conveyance at a prescribed timing.

The vacuum chamber 111 draws air through the holes of the conveyance belt 107, and therefore, the paper p is conveyed in a state that it is adsorbed onto the conveyance belt 107 in a lower side of the inkjet head 115. Thus, the respective inkjet heads 115 and the paper p can keep a fixed space from each other. The pretreatment liquid and the ink of each color are discharged from the inkjet heads 115S, 115C, 115M, 115Y and 115Bk, respectively in synchronism with the timing for conveying the paper p from the resist roller pair 106. Thus, a color image is formed at a desired position of the paper p. The paper p having an image formed thereon is outputted into a paper output tray 118 by the conveyance roller pairs 112, 113 and 114.

In the embodiment of the invention, the pretreatment liquid to be discharged from the inkjet head 115S contains a specified organometal salt and an aqueous solvent containing water and a specified butane derivative. The butane derivative is at least one member selected from the group consisting of 3-methoxy-3-methyl-1-butanol, 1,3-butylene glycol and isoprene glycol.

A solvent which is contained in the pretreatment liquid to be applied onto plain paper is required to have appropriate penetration properties into plain paper. The lower the polarity of a solvent, namely the stronger the hydrophobicity of a solvent, the higher the penetration properties into plain paper are. Accordingly, it is necessary to choose a solvent while taking into consideration both penetration properties and image quality. Furthermore, it is desirable that deterioration of paper to be caused due to the solvent, such as curl or cockling is small as far as possible.

The plain paper as referred to in this specification refers to paper which, when an inkjet head or the like is used, requires coating of a pretreatment liquid for the purpose of enhancing the image quality. That is, the plain paper as referred to herein does not include papers in which an additive is added for the purpose of increasing the image quality, such as inkjet papers, glossy papers and printing papers.

At least one butane derivative selected from the group consisting of 3-methoxy-3-methyl-1-butanol, 1,3-butylene glycol and isoprene glycol is able to fulfill this requirement. Moreover, such a butane derivative is relatively low in volatility as compared with water, has an optimal discharge performance for inkjet and is able to increase the quality of an image to be formed on plain paper. The foregoing butane derivative may be used singly or in combination of two or more kinds thereof.

Examples of the water include pure water and ion-exchanged water. It is desirable that the water accounts for from 40 to 90% by weight of the pretreatment liquid. When the amount of water is less than 40% by weight of the pretreatment liquid, the penetration effect is too large so that a sufficient reaction as the pretreatment liquid is not obtained. On the other hand, when it exceeds 90% by weight, a sufficient penetration effect is not obtained, and influences such as cockling or curl are generated on a non-negligible level. It is more preferable that the water accounts for from 50 to 80% by weight of the pretreatment liquid.

The organometal salt is blended in the pretreatment liquid for the purpose of increasing the image quality on plain paper upon reaction with a coloring material in the ink composition. According to circumstances, the organometal salt also reacts with a polysaccharide or a resin component in the ink. As a matter of course, it is required that the organometal salt is soluble in water.

The organometal salt which is used in the embodiment of the invention is essentially required to have COO⁻ in an organic skeleton thereof. Specific examples of the anion include an acetate ion, a propionate ion and a lactate ion.

Examples of the cation to be contained in the organometal salt include Na⁺, K⁺, Ca²⁺, Mg²⁺, Cu²⁺, Ni²⁺, Ba²⁺, Al³⁺ and Fe³⁺. When the valence of the metal ion is high as divalent or polyvalent, it is possible to increase an image density.

Calcium lactate and calcium propionate are especially preferable as the organometal salt because not only blur or bleeding can be inhibited, but a high image density is obtained.

An amount of the organometal salt in the pretreatment liquid is determined within the range where reduction of the print quality or clogging does not occur. When the content of the organometal salt is too low, a desired effect cannot be sufficiently obtained. On the other hand, even when the organometal salt is excessively contained, it is not meant that a markedly enormous effect is exhibited. The amount of the organometal salt is preferably from about 2 to 30% by weight, and more preferably from about 5 to 20% by weight. So far as the addition amount falls within the foregoing range, the storage stability of the pretreatment liquid is high, and the generation of a deposit or the like with a lapse of time is suppressed. As a result, it is possible to keep the stability of discharge performance.

In addition to the foregoing components, a wetting agent may be contained in an amount of not more than 10% by weight in the pretreatment liquid according to an embodiment of the invention. Examples of the wetting agent include glycerin and triethylene glycol. Though such a component is a material having an extremely high moisturizing effect, there is a possibility that it brings influences against paper, especially adverse influences on cockling or curl. When the content of the wetting agent is not more than 10% by weight, it is possible to secure the moisturizing effect while inhibiting the deterioration of paper.

Moreover, if desired, an additive selected from a surfactant, a water-soluble polymer, a high-boiling point organic solvent, an antiseptic and a fungicide can be blended in the pretreatment liquid.

The surfactant acts as a surface tension modifier and is selected from an acethylene glycol based surfactant, a fluorine based surfactant and so on.

Examples of the acethylene glycol based surfactant include 2,4,7,9-tetramethyl-5-decyne-4,7-diol, 3,6-dimethyl-4-octyne-3,6-diol and 3,5-dimethyl-1-hexyn-3-ol. Specifically, SURFYNOL 104, SURFYNOL 82, SURFYNOL 465, SURFYNOL 485 and SURFYNOL TG (all of which are manufactured by Air Products and Chemicals, Inc.) and the like may be used. In particular, SURFYNOL 465, SURFYNOL 104 and SURFYNOL TG are preferably used because they exhibit a favorable print quality.

Examples of the fluorine based surfactant include a perfluoroalkyl ethylene oxide adduct, a perfluoroalkylamine oxide, a perfluoroalkyl carboxylic acid salt and a perfluoroalkyl sulfonic acid. In particular, in view of the matter that a favorable print quality is obtainable, MEGAFAC F-443, MEGAFAC F-444, MEGAFAC F-470 and MEGAFAC F-494 (all of which are manufactured by DIC Corporation); NOVEC FC-430 and NOVEC FC-4430 (all of which are manufactured by 3M Corporation); and SURFLON S-141, SURFLON S-145, SURFLON S-111N and SURFLON S-113 (all of which are manufactured by Seimi Chemical Co., Ltd.) are preferable.

The foregoing acethylene glycol based surfactant or fluorine based surfactant may be used singly or in admixture of two or more kinds thereof. Of these, a fluorine based surfactant is preferable. This is because when used in a small amount, the fluorine based surfactant is able to reduce the surface tension and to enhance wettability between a discharge head and an ink and is also low in blur of a print image.

The surfactant is able to exhibit the effect so far as it is contained in an amount of from about 0.05 to 1.0% by weight of the whole amount of the pretreatment liquid.

By adding the water-soluble polymer in the pretreatment liquid, it is possible to regulate the pretreatment liquid so as to have an optimal viscosity for inkjet discharge. As the water-soluble polymer, methyl celluloses, ethyl celluloses, polyvinyl alcohols, polyvinylpyrrolidones, polysaccharides and the like can be used.

By adding the water-soluble polymer, it is possible to regulate the pretreatment liquid so as to have a viscosity falling within an appropriate range in discharging it by an inkjet head. The appropriate viscosity range as the pretreatment liquid for inkjet is preferably not more than about 30 mPa·s, and more preferably not more than 20 mPa·s at 25° C. According to this, the stability regarding printing omission, flying properties or the like becomes more favorable.

The water-soluble polymer has an action to control the penetration of a color ink into paper, and this action is called an anchor effect. The water-soluble polymer has an effect for more increasing the image quality in addition to an improving effect of the image quality due to a reaction between the metal salt and the color ink. However, when used as the pretreatment liquid for inkjet discharge, it is desirable that the water-soluble polymer is added in a small amount, thereby formulating it so as to fall within physical properties in viscosity close to a Newtonian fluid. The appropriate addition amount can be properly chosen depending upon the kind of the water-soluble polymer. For example, in case of a polyvinylpyrrolidone having a molecular weight of about 40,000, when it is contained in amount of from about 5 to 15% by weight in the pretreatment liquid, the effect can be obtained.

The high-boiling point organic solvent acts as an anti-drying agent, and examples thereof include polyhydric alcohols and nitrogen-containing heterocyclic compounds. Examples of the polyhydric alcohol include ethylene glycol, diethylene glycol, polyethylene glycol, polypropylene glycol, 1,5-pentanediol, 1,6-hexanediol, glycerin (glycerol), 1,2,6-hexanetriol, 1,2,4-butanetriol, 1,2,3-butanetriol and petriol. Examples of the nitrogen-containing heterocyclic compound include N-methyl-2-pyrrolidone, N-hydroxyethyl-2-pyrrolidone, 2-pyrrolidone, 1,3-dimethylimidazolidinone and ε-caprolactam.

Furthermore, there are exemplified an amine such as monoethanolamine, diethanolamine, triethanolamine, monoethylamine, diethylamine and triethylamine; a sulfur-containing compound such as dimethyl sulfoxide, sulfolane and thiodiethanol; propylene carbonate; ethylene carbonate; and γ-butyrolactone.

Examples of the antiseptic or fungicide include sodium benzoate, sodium pentachlorophenol, sodium 2-pyridinethiol-1-oxide, sodium sorbate, sodium dehydroacetate and 1,2-dibenzisothiazolin-3-one (for example, PROXEL CRL, PROXEL BDN, PROXEL GXL, PROXEL XL-2 and PROXEL TN, all of which are manufactured by Imperial Chemical Industries Limited).

Furthermore, the pretreatment liquid in the embodiment of the invention may be blended with from 0.2 to 10% by weight of a fluorescent brightener. In that case, the quality of the image which is formed on the plain paper can further be increased. Also, it is also possible to easily verify whether or not discharge of the pretreatment liquid is right or wrong upon irradiation with ultraviolet rays.

As the ink composition to be injected onto plain paper after the pretreatment, an aqueous ink which meets the following condition can be used. Specifically, the aqueous ink is an aqueous ink in which when a coloring material, or a polysaccharide, a water-soluble polymer material or the like in the ink reacts due to a reaction with the pretreatment liquid, thereby printing the ink on a recording medium, the image quality can be enhanced.

An ink solvent is composed mainly of water and can further contain the same components as in the pretreatment liquid. As the coloring material, any of a dye and a pigment is useful. However, it is desirable that an active group having high reactivity with the metal salt in the pretreatment liquid, such as a COO⁻ group, is contained in a dye or on the surface of a pigment. The active group may be contained in other component than the coloring material component. For example, the active group may be contained in a resin component such as polysaccharides and is properly chosen depending upon the kind of the ink.

The pigment is not particularly limited, and any of an inorganic pigment and an organic pigment may be used. Examples of the inorganic pigment include titanium oxide and iron oxide. Furthermore, carbon blacks which are manufactured by a publicly known method, for example, a contact method, a furnace method, a thermal method, etc. may be used.

Examples of the organic pigment which can be used include an azo pigment (for example, an azo lake pigment, an insoluble azo pigment, a condensed azo pigment, a chelate azo pigment, etc.), a polycyclic pigment (for example, a phthalocyanine pigment, a perylene pigment, a perinone pigment, an anthraquinone pigment, a quinacridone pigment, a dioxazine pigment, a thioindigo pigment, an isoindolinone pigment, a quinophthalone pigment, etc.), a dye chelate (for example, a basic dye type chelate, an acid dye type chelate, etc.), a nitro pigment, a nitroso pigment and Aniline Black.

Specific examples of the carbon black which is used as the black ink include No. 2300, No. 900, MCF88, No. 33, No. 40, No. 45, No. 52, MA7, MA8, MA100 and No. 2200B (all of which are manufactured by Mitsubishi Chemical Corporation); RAVEN 5750, RAVEN 5250, RAVEN 5000, RAVEN 3500, RAVEN 1255 and RAVEN 700 (all of which are manufactured by Columbian Chemicals Company); REGAL 400R, REGAL 330R, REGAL 660R, MOGUL L, MONARCH 700, MONARCH 800, MONARCH 880, MONARCH 900, MONARCH 1000, MONARCH 1100, MONARCH 1300 and MONARCH 1400 (all of which are manufactured by Cabot Corporation); and COLOR BLACK FW1, COLOR BLACK FW2, COLOR BLACK FW2V, COLOR BLACK FW18, COLOR BLACK FW200, COLOR BLACK S150, COLOR BLACK S160, COLOR BLACK S170, PRINTEX 35, PRINTEX U, PRINTEX V, PRINTEX 140U, SPECIAL BLACK 6, SPECIAL BLACK 5, SPECIAL BLACK 4A and SPECIAL BLACK 4 (all of which are manufactured by Degussa AG).

Specific examples of the pigment which is used in the yellow ink include C.I. Pigment Yellow 1, C.I. Pigment Yellow 2, C.I. Pigment Yellow 3, C.I. Pigment Yellow 12, C.I. Pigment Yellow 13, C.I. Pigment Yellow 14C, C.I. Pigment Yellow 16, C.I. Pigment Yellow 17, C.I. Pigment Yellow 73, C.I. Pigment Yellow 74, C.I. Pigment Yellow 75, C.I. Pigment Yellow 83, C.I. Pigment Yellow 93, C.I. Pigment Yellow 95, C.I. Pigment Yellow 97, C.I. Pigment Yellow 98, C.I. Pigment Yellow 109, C.I. Pigment Yellow 110, C.I. Pigment Yellow 114, C.I. Pigment Yellow 128, C.I. Pigment Yellow 129, C.I. Pigment Yellow 138, C.I. Pigment Yellow 150, C.I. Pigment Yellow 151, C.I. Pigment Yellow 154, C.I. Pigment Yellow 155, C.I. Pigment Yellow 180 and C.I. Pigment Yellow 185.

Specific examples of the pigment which is used in the magenta ink include C.I. Pigment Red 5, C.I. Pigment Red 7, C.I. Pigment Red 12, C.I. Pigment Red 48(Ca), C.I. Pigment Red 48(Mn), C.I. Pigment Red 57(Ca), C.I. Pigment Red 57:1, C.I. Pigment Red 112, C.I. Pigment Red 122, C.I. Pigment Red 123, C.I. Pigment Red 168, C.I. Pigment Red 184, C.I. Pigment Red 202 and C.I. Pigment Violet 19.

Specific examples of the pigment which is used in the cyan ink include C.I. Pigment Blue 1, C.I. Pigment Blue 2, C.I. Pigment Blue 3, C.I. Pigment Blue 15:3, C.I. Pigment Blue 15:4, C.I. Pigment Blue 15:34, C.I. Pigment Blue 16, C.I. Pigment Blue 22, C.I. Pigment Blue 60, C.I. Vat Blue 4 and C.I. Vat Blue 60.

Since the ink composition to be used in the embodiment of the invention is an inkjet ink, it is preferable that the pigment has an average particle size falling within the range of from about 1 to 300 nm. It is more preferable that the pigment has an average particle size falling within the range of from about 10 to 200 nm.

As the dye, various dyes which are used in an inkjet recording ink, for example, direct dyes, acid dyes, food dyes, reactive dyes and disperse dyes can be used.

In particular, dyes having a COO⁻ group or an SO₃⁻ group are desirable. Examples thereof include C.I. Direct Yellow 8, C.I. Direct Yellow 11, C.I. Direct Yellow 24, C.I. Direct Yellow 26, C.I. Direct Yellow 27, C.I. Direct Yellow 28, C.I. Direct Yellow 33, C.I. Direct Yellow 44, C.I. Direct Yellow 50, C.I. Direct Orange 6, C.I. Direct Orange 8, C.I. Direct Orange 29, C.I. Direct Orange 102, C.I. Direct Red 1, C.I. Direct Red 2, C.I. Direct Red 4, C.I. Direct Red 13, C.I. Direct Red 17, C.I. Direct Red 20, C.I. Direct Red 33, C.I. Direct Red 37, C.I. Direct Red 44, C.I. Direct Red 46, C.I. Direct Red 62, C.I. Direct Red 75, C.I. Direct Blue 1, C.I. Direct Blue 2, C.I. Direct Blue 6, C.I. Direct Blue 15, C.I. Direct Blue 22, C.I. Direct Blue 25, C.I. Direct Blue 76, C.I. Direct Blue 77, C.I. Direct Blue 86, C.I. Direct Blue 108 and C.I. Direct Blue 120.

Besides, a high-boiling point organic solvent as the anti-drying agent, an antiseptic, a fungicide, a surfactant and the like may be added as the need arises. The same materials as those in the case of the pretreatment liquid can be used as such an additive.

Since the ink composition to be used in the embodiment of the invention is used for inkjet recording, it is required to have an appropriate viscosity for discharge from a nozzle of a head in an inkjet printer. Specifically, a viscosity of the ink composition is preferably from 5 to 20 mPa·s at 25° C.

In the inkjet recording method according to the embodiment of the invention, prior to forming an image on plain paper using an ink composition, the plain paper is treated with a pretreatment liquid containing a specified butane derivative and an organometal salt. As described previously, the pretreatment liquid according to the embodiment of the invention appropriately penetrates into plain paper, thereby enabling one to suppress deterioration of paper and to realize high-quality printing.

Since the pretreatment liquid containing a specified butane derivative and an organometal salt is used, an image with high quality can be formed on plain paper without causing deterioration of paper by the method according to the embodiment of the invention. In particular, in case of adopting multi-drop printing, since the amount of the metal salt per unit area can be controlled, it is easy to regulate the image quality. As a result, a clear image is obtainable.

Examples and Comparative Examples of the invention are hereunder described.

First, 11 kinds of pretreatment liquids were prepared according to formulations as shown in the following Table 1. In preparing each of the pretreatment liquids, the respective components were mixed and then stirred for one hour using a stirrer. Thereafter, the resulting mixture was filtered through a 0.2-μm membrane filter, thereby obtaining a desired pretreatment liquid.

TABLE 1

| | 1 | 2 | 3 | 4 | 5 | 6 | 7 | 8 | 9 | 10 | 11 |
|---|---|---|---|---|---|---|---|---|---|---|---|
| Water | 74.4 | 69.4 | 68.9 | 68.9 | 69.4 | 74.4 | 69.4 | 53.9 | 58.9 | 58.9 | 74.4 |
| 3-Methoxy-3-methyl-1-butanol | 20 | — | 10 | — | 10 | — | 10 | — | — | — | 20 |
| 1,3-Butylene glycol | — | 20 | — | — | — | 10 | — | 20 | — | — | — |
| Isoprene glycol | — | — | — | 10 | — | — | — | — | — | — | — |
| Glycerin | — | — | 10 | — | — | 5 | 10 | 20 | 30 | 30 | — |
| Triethylene glycol | — | — | — | 10 | 10 | — | — | — | — | — | — |
| Calcium lactate | 5 | — | — | — | — | — | — | 5 | — | — | — |
| Calcium propionate | — | 10 | — | 10 | 10 | 10 | — | — | — | — | — |
| Calcium acetate | — | — | 10 | — | — | — | 10 | — | — | — | — |
| Sodium chloride | — | — | — | — | — | — | — | — | 10 | — | — |
| Calcium chloride | — | — | — | — | — | — | — | — | — | 10 | 5 |
| PROXEL XL-2 | 0.1 | 0.1 | 0.1 | 0.1 | 0.1 | 0.1 | 0.1 | 0.1 | 0.1 | 0.1 | 0.1 |
| SURFYNOL 465 | 0.5 | 0.5 | 1 | 1 | 0.5 | 0.5 | 0.5 | 1 | 1 | 1 | 0.5 |

The components which are used herein are as follows.
3-Methoxy-3-methyl-1-butanol: manufactured by Kuraray Co., Ltd.
1,3-Butylene glycol: manufactured by Kyowa Hakko Chemical Co., Ltd.
Isoprene glycol: manufactured by Kuraray Co., Ltd.
Glycerin: manufactured by Sakamoto Yakuhin Kogyo Co., Ltd.
Triethylene glycol: manufactured by Mitsui Chemicals, Inc.
PROXEL XL-2: manufactured by Arch Chemical, Inc.

On the other hand, each ink composition was prepared using the following components. In preparing each of the ink compositions, the respective components were mixed and then stirred for one hour using a stirrer. Thereafter, the resulting mixture was filtered through a 1-μm membrane filter.

| | | |
|---|---|---|
| Glycerin: | 30% | by weight |
| CARBON BLACK CAB-0-JET300 | 40% | by weight |
| (manufactured by Cabot Corporation): | | |
| SURFYNOL 465 (manufactured by Air | 1% | by weight |
| Products and Chemicals, Inc.): | | |
| PROXEL XL-2: | 0.1% | by weight |

| | |
|---|---|
| Water | Balance |

Color inks are obtainable by changing the CARBON BLACK CAB-O-JET300 as the pigment to YELLOW CAB-O-JET270Y, CYAN CAB-O-JET250C or MAGENTA CAB-O-JET260M.

The print quality was evaluated by printing on plain paper using the prepared pretreatment liquid and black ink. For the printing, an inkjet recording apparatus mounted with a piezo head, CB1 (manufactured by Toshiba Tec Corporation) was used, and Toshiba Copy Paper was prepared as the plain paper.

The print quality was evaluated with respect to blur, image density and cockling.

### (Blur)

First of all, the pretreatment liquid was printed on the plain paper at 100% duty, and letters were then printed with the black ink. After drying, the presence or absence of the generation of blur on the letters was examined and evaluated according to the following criteria. The evaluation was made with respect to the foregoing plain paper.

◯: No blur was generated, and the obtained image was clear.

Δ: Blur was generated to an extent that an outline of the obtained image was unclear.

### (Image Density)

First of all, the pretreatment liquid was printed on the plain paper at 100% duty, and the black ink was then solid printed at 100% duty. After drying, the image density of a solid printed area was measured by a spectrophotometer X-Rite. A reflectance was determined and defined as ΔT, and then evaluated according to the following criteria.

◯: ΔT≧1.3

Δ: 1.0≦ΔT<1.3

### (Cockling)

Similar to the measurement of image density, the pretreatment liquid was printed on the plain paper at 100% duty, and the black ink was then solid printed at 100% duty, thereby obtaining a sample. The degree of cockling was determined using a laser displacement gauge, and concave and convex of paper were evaluated according to the following criteria.

◯: Less than 1.0 mm

Δ: 1.0 mm or more and less than 2.0 mm

The obtained results are summarized in the following Table 2. The case where none or one of the foregoing three evaluations is rated as “B” is defined to fall within a tolerable range. The case where two or more of them are rated as “Δ” is defined as “NG”.

TABLE 2

| | 1 | 2 | 3 | 4 | 5 | 6 | 7 | 8 | 9 | 10 | 11 |
|---|---|---|---|---|---|---|---|---|---|---|---|
| Blur | ◯ | Δ | Δ | ◯ | ◯ | ◯ | ◯ | ◯ | Δ | Δ | Δ |
| Image | Δ | ◯ | ◯ | ◯ | Δ | Δ | ◯ | ◯ | Δ | ◯ | Δ |
| density | | | | | | | | | | | |
| Cockling | ◯ | ◯ | ◯ | ◯ | ◯ | ◯ | ◯ | Δ | Δ | Δ | ◯ |

As shown in the foregoing Table 2, in the pretreatment liquids Nos. 1 to 8, comprehensively favorable results are obtained with respect to the blur, image density and cockling. Each of these pretreatment liquids contains an organometal salt as well as a butane derivative selected from 3-methoxy-3-methyl-butanol, 1,3-butylene glycol and isoprene glycol. That is, each of these pretreatment liquids contains an organometal salt having COO⁻.

When the prescribed butane derivative and organometal salt are contained, penetration drying properties of the pretreatment liquid become optimal, and cockling generated on paper is reduced. Moreover, an image with high density can be formed. In particular, when the organometal salt having a lactate or a propionate is contained, higher effects are obtained, and the balance between the image quality and the discharge performance is adequately maintained.

In the pretreatment liquids Nos. 9 to 11 not containing an organometal salt in addition to the prescribed butane derivative, the performance falling within a comprehensively passing zone cannot be obtained. In these pretreatment liquids, blur is certainly generated. In addition to this, in the pretreatment liquid No. 10, cockling is generated; and in the pretreatment liquid No. 11, the image density is inferior. The pretreatment liquid No. 9 is inferior in all of the performances, and its print quality is the lowest.

It is noted from the results of the pretreatment liquid No. 7 that even when the wetting agent such as glycerin is contained in an amount of not more than 10% by weight, cockling is not affected at all.

According to the inkjet recording method of an embodiment of the invention, in a method for inkjet recording on plain paper by a two-liquid feeding method, a pretreatment with stable discharge performance and high-quality printing can be performed while suppressing deterioration of plain paper.

Also, the pretreatment liquid according to an embodiment of the invention is able to perform a pretreatment with stable discharge performance while suppressing deterioration of plain paper.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A method for inkjet printing comprising:
attaching a colorless pretreatment liquid onto plain paper, the pretreatment liquid containing at least one butane derivative selected from the group consisting of 3-methoxy-3-methyl-1-butanol, 1,3-butylene glycol and isoprene glycol, water and an organometal salt having COO⁻ in an organic skeleton thereof; and
injecting at least one ink composition capable of reacting with the pretreatment liquid onto the plain paper after the pretreatment, thereby forming an image, the ink composition containing a coloring material and water.

2. The method according to claim 1, wherein forming the image is performed using a single kind of an ink composition.

3. The method according to claim 2, wherein the ink composition is selected from the group consisting of a black ink, a cyan ink, a magenta ink and a yellow ink.

4. The method according to claim 1, wherein forming the image is performed using two or more kinds of an ink composition.

5. The method according to claim 4, wherein the ink composition is selected from the group consisting of a black ink, a cyan ink, a magenta ink and a yellow ink.

6. The method according to claim 1, wherein attaching the pretreatment liquid onto the plain paper is performed by an inkjet printing system of a multi-drop type.

7. The method according to claim 1, wherein the coloring material in the ink composition has COO⁻ or SO₃⁻.

8. A pretreatment liquid for inkjet recording configured to be attached onto plain paper before forming an image with an ink composition on the plain paper by an inkjet printer, the pretreatment liquid comprising at least one butane derivative selected from the group consisting of 3-methoxy-3-methyl-1-butanol, 1,3-butylene glycol and isoprene glycol, water and an organometal salt having COO⁻ in an organic skeleton thereof.

9. The pretreatment liquid according to claim 8, wherein the water is contained in an amount of from 40 to 90% by weight.

10. The pretreatment liquid according to claim 8, wherein the organometal salt contains an anion selected from the group consisting of an acetate ion, a propionate ion and a lactate ion.

11. The pretreatment liquid according to claim 8, wherein the organometal salt contains a metal ion selected from the group consisting of Na⁺, K⁺, Ca²⁺, Mg²⁺, CU²⁺, Ni²⁺, Ba²⁺, Al³⁺ and Fe³⁺.

12. The pretreatment liquid according to claim 11, wherein the metal ion is divalent or polyvalent.

13. The pretreatment liquid according to claim 8, wherein the organometal salt is selected from the group consisting of calcium lactate and calcium propionate.

14. The pretreatment liquid according to claim 8, wherein the organometal salt is contained in an amount of from 2 to 30% by weight.

15. The pretreatment liquid according to claim 8, further comprising not more than 10% by weight of a wetting agent.

16. The pretreatment liquid according to claim 15, wherein the wetting agent is glycerin.

17. The pretreatment liquid according to claim 8, further comprising a water-soluble polymer selected from the group consisting of methyl celluloses, ethyl celluloses, polyvinyl alcohols, polyvinylpyrrolidones and polysaccharides.

18. The pretreatment liquid according to claim 8, further comprising a surfactant.

19. The pretreatment liquid according to claim 8, wherein a viscosity is not more than 20 mPa·s at 25° C.
